(19) United States
(12) Patent Application Publication
(10) Pub. No.: US 2011/0010123 A1
(43) Pub. Date: Jan. 13, 2011

(54) Method of Pressure Testing

(75) Inventor: Arthur Bosshart, Tampa, FL (US)

Correspondence Address: AKERMAN SENTERFITT, P.O. BOX 3188, WEST PALM BEACH, FL, 33402-3188, US

(73) Assignee: TECO Energy, Inc., Tampa, FL (US)

(21) Appl. No.: 12/641,042

(22) Filed: Dec. 17, 2009

Related U.S. Application Data
(60) Provisional application No. 61/223,989, filed on Jul. 8, 2009.
(60) Provisional application No. 61/223,981, filed on Jul. 8, 2009.

(51) Int. Cl. G06F 19/00; G01L 27/00

(52) U.S. Cl. 702/98

(57) ABSTRACT

A computer-based method for pressure testing. The method can include determining physical characteristics of a system of conduits. Additionally, the method can include determining a pressure limit associate with the system based on the physical characteristics. The method can also include identifying a target portion of a conduit in the system that may have a thermal gradient and positioning a probe for measuring temperature along a middle portion of the target portion. The method can include determining an average rate of temperature change along the target portion based on the temperature data from the probe for a period of time and determining a thermal mixing zone between the probe and another probe in the system based on a type of substance between the probes. Furthermore, the method can include determining a thermal model for the target portion based on the determined average rate of temperature change, a volume of the target portion, and the determined thermal mixing zone. Moreover, the method can include obtaining pressure data for the target portion by pressure testing the identified target portion, and adjusting the obtained pressure data based on the thermal model.

### CROSS-REFERENCES TO RELATED APPLICATIONS

This application claims the benefit of U.S. Provisional Patent Application Ser. No. 61/223,989 filed on Jul. 8, 2009 and U.S. Provisional Patent Application Ser. No. 61/223,981 filed on Jul. 8, 2009, the disclosures of which are hereby incorporated by reference. This application is related to Applicant's patent application entitled “System for Pressure Testing”, attorney docket No. 7082-6, filed contemporaneously herewith, the disclosure of which is hereby incorporated by reference.

### FIELD OF THE INVENTION

The present invention is related to the fields of pressure and temperature testing, and more particularly, to computer-based methods for pressure testing.

### BACKGROUND OF THE INVENTION

In order for a particular system to maintain compliance with pressure testing requirements, it is important to utilize a pressure testing method which accurately takes into account the various factors that may influence a pressure test. Pressure testing methods, however, often vary considerably in scope and overall effectiveness in accurately testing pressure in a target system. As a result, some pressure testing methods may report that a target system has passed a particular test when the system should have failed and other pressure testing methods may report that a target system failed a test when in reality the system should have passed.

Therefore, it is desirable to utilize pressure testing methods which comprehensively analyze the various components and dimensions of a target system in order to determine pressure limits and leaks within various segments of the target system. Additionally, it is further desirable to account for the various factors and conditions which may potentially affect the system and/or alter the results of a pressure test.

### SUMMARY OF THE INVENTION

The present invention is directed to methods for pressure testing various types of systems, including a system of conduits. Also, the present invention is directed to systems and methods for utilizing temperature probes for generating thermal profiles of a system so as to adjust and/or supplement the results of a pressure test conducted on the system.

One embodiment of the invention is a computer-based method for pressure testing in a system. The method can include determining one or more physical characteristics of a system of conduits, wherein the one or more physical characteristics comprises one or more dimensions of the conduits, determining a pressure limit associated with the system based on the one or more physical characteristics, identifying a target portion of one or more conduits in the system, wherein the target portion is susceptible to having a thermal gradient, positioning a probe along a middle portion of the identified target portion, wherein the probe obtains temperature data along the identified target portion, determining an average rate of temperature change along the identified target portion based on the obtained temperature data for a designated period of time, determining a thermal mixing zone between the probe and another probe in the system based on a type of substance between the probe and the another probe, determining a thermal model for the identified target portion based on the determined average rate of temperature change, a volume of the identified target portion, and the determined thermal mixing zone, obtaining pressure data for the identified target portion by pressure testing the identified target portion, and adjusting the obtained pressure data based on the thermal model.

Another embodiment of the invention is a computer-based method for pressure testing. The method can include determining a pressure limit associated with a system of conduits, identifying a target portion of one or more conduits in the system based on the susceptibility of the target portion to having a thermal gradient, positioning a probe along the target portion, obtaining temperature data associated with the target portion from the probe at a defined rate for a designated period of time, determining an average rate of temperature change along the target portion based on the obtained temperature data, defining a thermal behavior of the target portion based on the determined average rate of temperature change, determining a thermal mixing zone between the probe and another probe in the system, generating a thermal model for the target portion based on at least one of the average rate of temperature change, the thermal behavior, a volume of the identified target portion, and the thermal mixing zone, obtaining pressure data for the target portion by pressure testing the target portion, and adjusting the obtained pressure data based on the thermal model.

Yet another embodiment of the invention is a computer-readable medium which contains computer-readable code that when loaded on a computer causes the computer to: determine a pressure limit associated with a system of conduits, identify a target portion of one or more conduits in the system based on the susceptibility of the target portion to having a thermal gradient, obtain temperature data associated with the target portion from a probe at a defined rate for a designated period of time, wherein the probe is operably coupled to the target portion, determine an average rate of temperature change along the target portion based on the temperature data, define a thermal behavior of the target portion based on the determined average rate of temperature change, generate a thermal model for the target portion based on at least one of the average rate of temperature change, the thermal behavior, and a volume of the target portion, obtain pressure data for the target portion by pressure testing the target portion, and adjust the obtained pressure data based on the thermal model.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for pressure testing in a system of conduits, according to one embodiment of the invention.

FIG. 2 is a table illustrating average rates of temperature change per hour detected at each probe in a system.

FIG. 3 is a graph displaying average rates of temperature change per hour detected at each probe in the system of FIG. 2.

FIG. 4 is a schematic view of a conduit featuring a thermal mixing zone between a set of probes.

FIG. 5 is a table illustrating average thermal temperature change across a system.

FIG. 6 is a table illustrating a leak rate calculation and pressure test results.

FIG. 7 is a table illustrating data from multiple test runs and corresponding results.

FIG. 8 is a flowchart of steps in a method for pressure testing, according to another embodiment of the invention.

### DETAILED DESCRIPTION

There are a variety of pressure test methods presently available for determining the pressures within a test system of conduits, such as the API 1110 pressure test method and other methods. Currently, these methods fail to account for temperature effects and changes that occur within a test system, particularly with respect to the effects of temperature changes of substances carried within the system. Temperature changes and variations can directly affect the measured pressure during a pressure test. As a result, these methods may result in causing a particular system to pass the pressure test when the system should have failed the test and fail the system when it should have passed. In fact, there are a variety of conditions and factors that can directly or indirectly affect the outcome of a pressure test of a system. Such conditions and factors can include, but are not limited to including, temperature changes of substances in a system, ambient temperature changes, the type of conduit materials, temperature changes of the conduits, the types of substances within the conduits, compressibility, the environment the conduits reside in, energy transfers between the system and the environment, thermal expansion rates, and the volume of the conduits that are tested.

Since current pressure testing methods do not fully take into account the aforementioned factors and conditions, the present invention can provide more robust pressure testing methods. For example, by monitoring the temperature of substances contained within the conduits of a system, pressure fluctuations in the system can be properly taken into account. Otherwise, a pressure fluctuation may have to be accounted for by reasoning that a product loss had occurred in the system, which can lead to the conclusion that there was a leak in the conduit tested when, in reality, there was no leak. If the heat capacity of the substance contained in the conduit and the thermal conductivity of the substance's surroundings are accounted for, then there would be a substantial delay between the ambient or environmental temperature change and the temperature change of the substance.

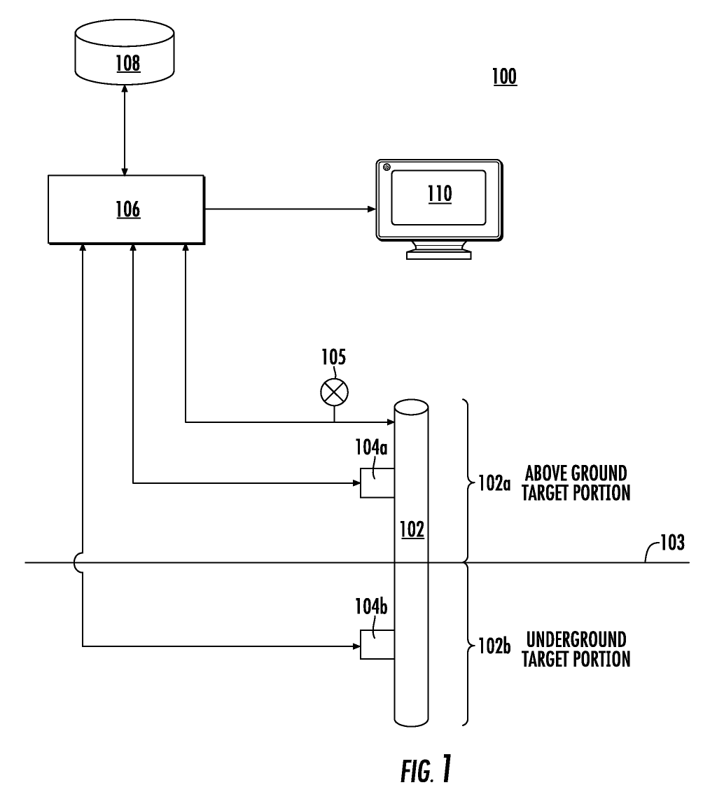

Referring initially to FIG. 1, a system 100 for pressure testing, according to one embodiment of the invention, is schematically illustrated. The system can include a series of conduits such as conduit 102, which can be configured to be a pipe, tube, tunnel, or other structure for carrying, transporting and/or containing various types of substances. Such substances can include, for example, various types of solids, liquids, and gases. As illustrated in FIG. 1, a portion 102a of conduit 102 can lie above ground 103 and another portion 102b of conduit 102 can lie under the ground 103. Of course, conduit 102 is not intended to be limited to the precise configuration as shown in FIG. 1 and any number and types of conduits can be utilized. The system 100 can also include one or more temperature probes/gauges such as probes 104a and 104b, which can be operably coupled to the conduit 102. In an embodiment, the probes 104 can be accurate to at least 0.01° Fahrenheit. However, probes of other sensitivities can also be utilized.

The system 100 can also include a pressure gauge 105 for measuring the pressure within various parts of the system 100. In an embodiment, the pressure gauge 105 can be accurate to at least 0.01 pounds per square inch (psi). Additionally, the system 100 can include a processor 106 which can be configured to process, manage, and configure data. Notably, the probes 104a-b and pressure gauge 105 can be operably coupled to the processor 106. For example, the probes 104a-b and pressure gauge 105 can be connected to the processor 106 wirelessly, using wires, or through other connection means. The processor 106 can be configured to receive and process data obtained from the probes 104a-b and pressure gauge 105, and can transmit the data for storage at database 108. After the processor 106 has received and processed the data, the data can be displayed via the display device 110. The display device 110 can, for example, be a monitor, a personal digital assistant, a mobile phone, or other display means.

Even though one conduit 102, two probes 104a-b, one pressure gauge 105, one processor 106, one database 108 and one display device 110 are shown in FIG. 1, it will be apparent to one of ordinary skill based on the description that a greater number of conduits, pressure gauges, processors, and databases and a greater or lesser number of temperature probes can be used according to the invention. Notably, the processor 106 can be implemented in hardwired, dedicated circuitry for performing the operative functions described herein. In another embodiment, the processor 106 can be implemented in computer-readable code configured to execute on a particular computing machine. In yet another embodiment, however, the processor 106 can be implemented in a combination of hardwired circuitry and computer-readable code.

Operatively, the processor 106 can be configured to determine or otherwise obtain, including through user input, one or more physical characteristics of the conduit 102 in the system 100. This can be performed by utilizing various types of sensors (not explicitly shown), which can transmit data about the conduit 102 to the processor 106. The physical characteristics can include one or more dimensions of the conduit 102, such as, but not limited to, the height, length, volume, and material of the conduit. Once the physical characteristics are ascertained, an upper and/or lower pressure limit of the conduit 102 can be determined, which can be based at least in part on the physical characteristics of the conduit 102. Next, target portions of the conduit 102 can be identified as being susceptible to having a thermal gradient. In FIG. 1, target portions 102a and 102b were found to be susceptible to having thermal gradients. After the target portions 102a and 102b have been identified, probes 104a and 104b can be placed along or otherwise coupled to a middle portion of the target portions 102a and 102b of the conduit 102, respectively. The probes 104a-b can measure temperature data for their respective portions and transmit the temperature data to the processor 106 for processing.

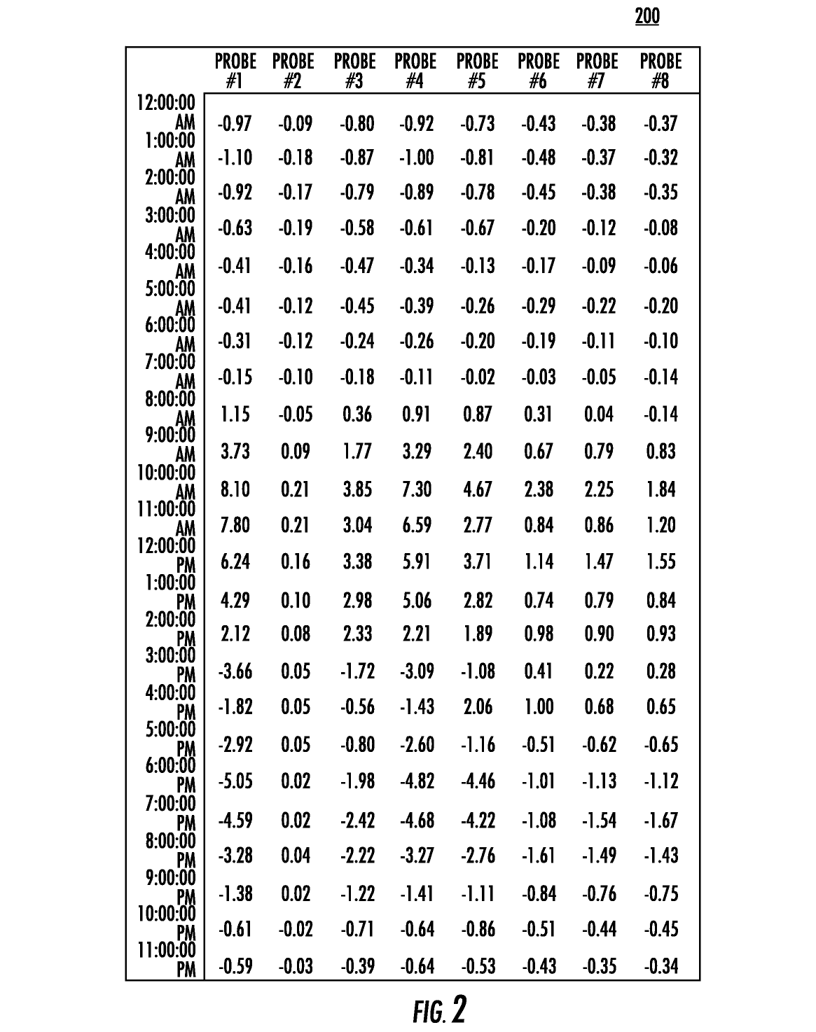

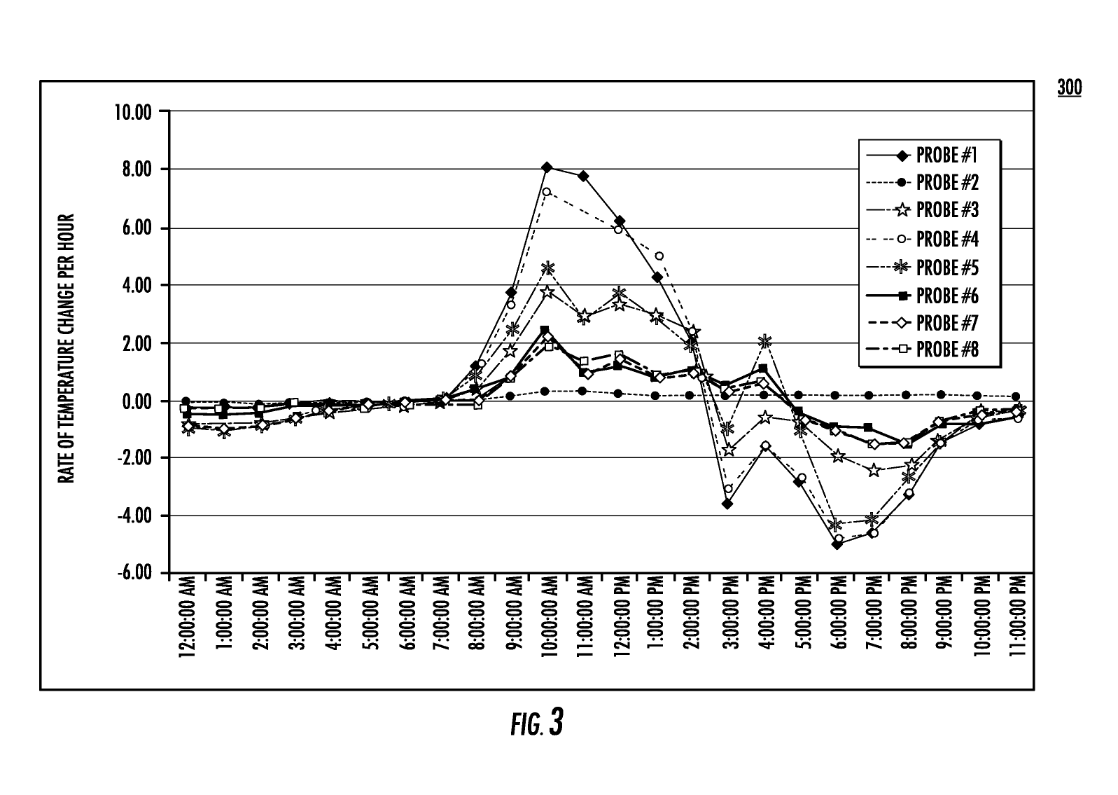

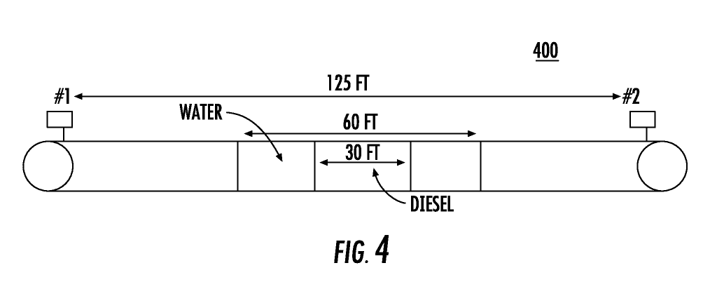

Once the processor 106 receives the data from the probes 102a-b, the processor 106 can begin to generate a thermal profile and can determine an average rate of temperature change along the identified target portions 102a-b based on the received temperature data for a designated period of time. FIG. 2, which depicts a table of average rate of temperature change data for a conduit system using eight probes, can be displayed by processor 106 on display device 110. The average rates of temperature change can then be utilized to determine the conduit 102 system's thermal behavior. FIG. 3 illustrates the thermal behavior of the conduit system of FIG. 2. In addition, one or more thermal mixing zones can be determined to exist between probes 104a-b in the system 100 based on a type of substance between the probes 104a-b. FIG. 4 illustrates the difference in mixing zone size that is dependent upon what substance is contained within the conduit. Additionally, FIG. 4 also serves to illustrate that a best engineering judgment can be used when estimating the percentage of a conduit or system of conduits which will be affected by thermal mixing. When all thermal zones/mixing zones are established, the values can be added by the processor 106 to determine the average thermal temperature change across the system in which the conduit 102 is a part of. The processor 106 can then generate the thermal model to be utilized for the identified target portions 102a-b. The thermal model can be based on the determined average rates of temperature change, the volumes of the identified target portions, the determined thermal mixing zones, and other factors.

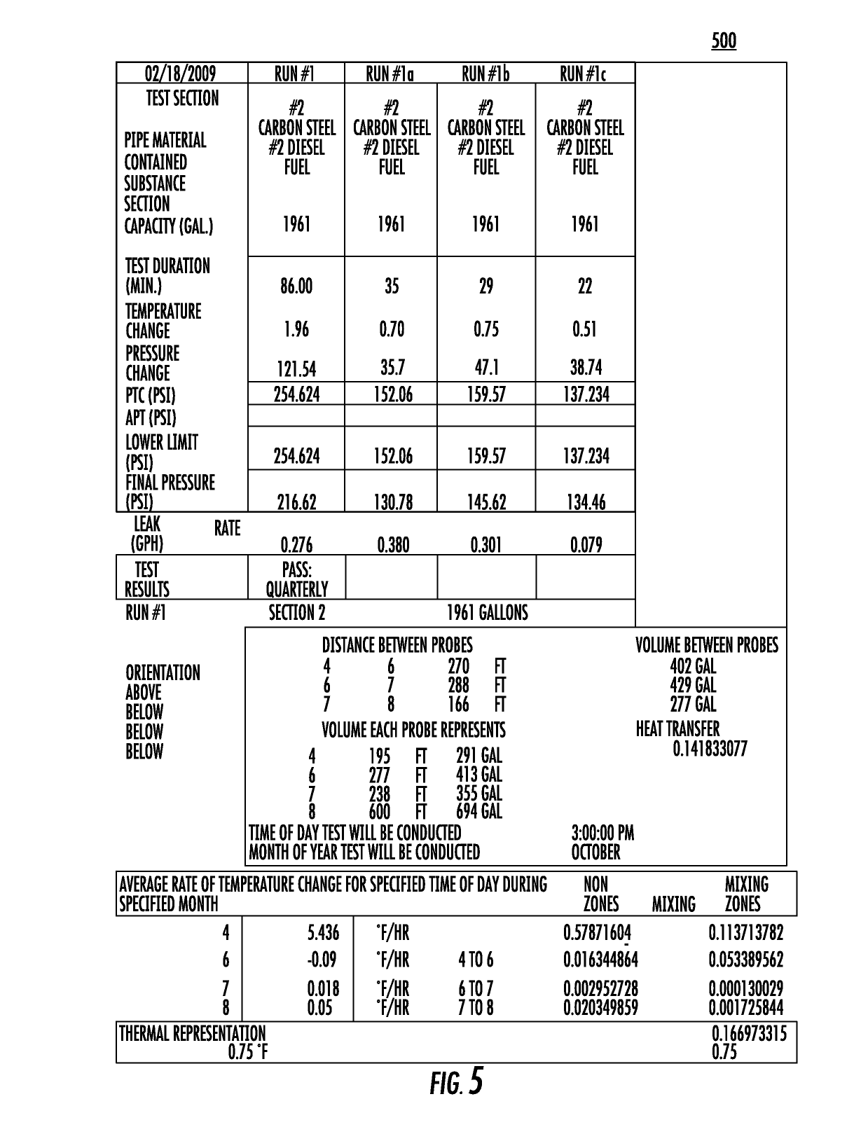

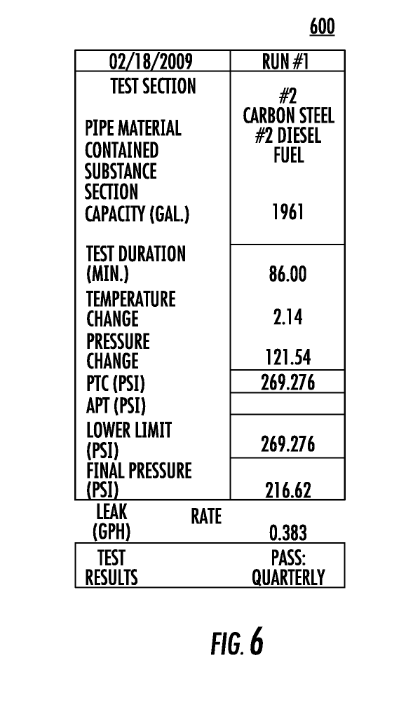

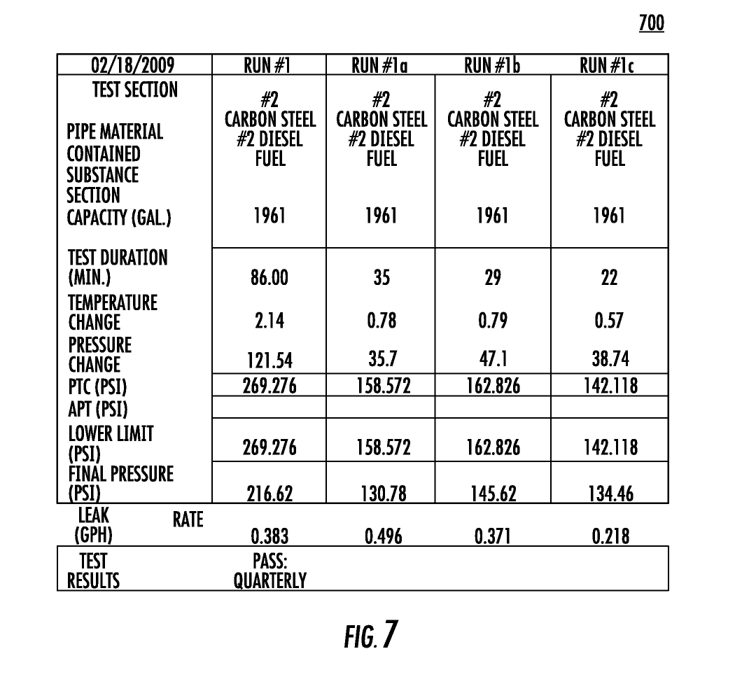

The pressure gauge 105 can record pressure measurements and transmit the measurements for the target portions 102a-b to the processor 106 for processing. FIG. 5 illustrates data for a series of pressure test runs and average thermal temperature change across a conduit system. The processor 106 can then adjust the obtained pressure data based on the generated thermal model and can determine the leak rate for conduit systems over a series of test runs. FIG. 6 features a table illustrating a leak rate calculation and pressure test results and FIG. 7 features a table illustrating data from multiple test runs and corresponding results. Notably, the system 100 can also be utilized to implement the methods described below, which describe the invention in further detail along with relevant calculations.

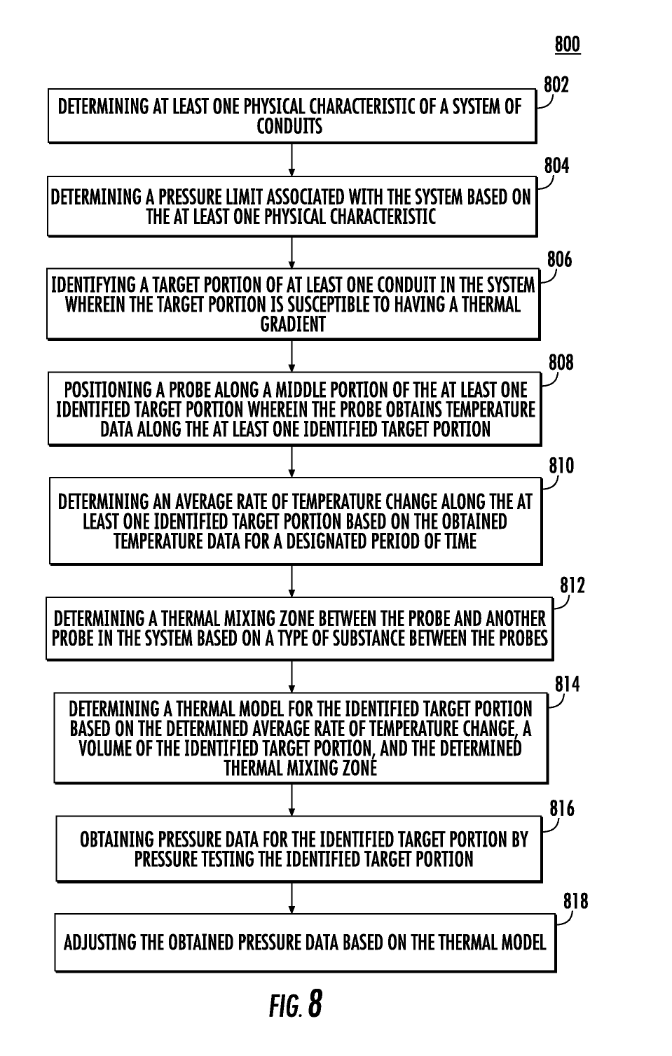

Referring now to FIG. 8, a flowchart is provided that illustrates certain method aspects of the invention. The flowchart depicts steps of a method 800 for pressure testing, which can account for temperature changes during a pressure test and can be utilized to supplement current API pressure testing methods. Notably, system 100's components or a variant thereof can be utilized to perform and/or implement the steps of method 800. The method 800 illustratively can include, beginning at step 802, determining one or more physical characteristics and factors of a system of conduits. Conduits can comprise pipes, tubes, tunnels, or other similar mechanisms capable of transporting, carrying, and/or storing materials. The physical characteristics can include, but are not limited to including, the types of material the conduits are made of, the quantity of materials, the types of substances that may reside in the conduits, the physical states of the substances (e.g. solid, liquid, gas), and one or more dimensions of the conduits. The factors can include any of the factors listed in this specification and other factors. Notably, the dimensions can include, but are not limited to including, the length, width, height, diameter, and volume of the conduits and/or other components in the system.

After determining the various physical characteristics and conditions/factors, referenced data for the physical characteristics and factors of the system can then be gathered. Such reference data can include, but is not limited to including, the thermal expansion coefficients of the conduit material and the substances contained within the conduit, and the compressibility of the substances. At step 804, the method 800 can include determining an upper and/or lower pressure limit associated with the system based on the one or more physical characteristics. Knowing the upper and lower pressure limits of the conduit system can aid in both safely and accurately conducting pressure tests. For example, conduits made of steel may have a higher pressure limit than a conduit made of a less dense and/or weaker material, and, therefore, can withstand greater pressures. During a pressure test, if the upper pressure limit is attained prior to the end of the test, then the pressure may be bled off down to a minimum of 125 percent of the operating pressure. If the pressure test is being conducted in operating conditions with decreasing temperatures, then the starting test pressure can be set near the upper pressure limit and the system can be repressurized if the pressure falls to within 125 percent of the operating pressure of the system if the testing duration requirements have not been met.

The maximum pressure/upper pressure limit can be defined as, but is not limited to being defined as, the maximum pressure that the components of the system of conduits can withstand during a pressure test. For example, if the system includes valves, piping, and flanges, the maximum pressure would be the amount of pressure such components can handle. When this maximum pressure/upper pressure limit is reached, the pressure can be bled off to 125 percent of the operating pressure of the system. The test pressure to be utilized during a pressure test can be defined as 125 percent of the operating pressure of the conduit system. This is to maintain conformity with the current API 1110 standard. It is important to note that other percentages can be utilized and the definition is not intended to be limited to 125 percent of the operating pressure. In addition to determining the upper and lower pressure limits and dimensions of the system, knowing the capacity of the system can aid in accurately determining leak rates and in determining the system's sensitivity to temperature changes. Also, the dimensions of the conduits in the system, the paths of the conduits (can be used in determining the length of the conduits), and the various sizes of the conduits in the system can be utilized in determining the capacity of the system.

The method 800 can include, at step 806, identifying a target portion of one or more conduits in the system, wherein the target portion is susceptible to having a thermal gradient. Thermal/temperature gradients can significantly alter the accuracy of a pressure test. As a result, it is important to determine the environment in which various parts of the conduit system reside. For example, it can be determined which parts of a particular pipe are above ground, below ground, in the shade, and exposed to the sun. Once the target portions of the conduits are identified in the system, the method 800 can include positioning a probe along a middle portion of each identified target portion at step 808. For example, as shown in FIG. 1, a portion 102a of conduit 102 resides above ground 103 and a probe 104a was placed in the middle portion of the portion 102a. Probe placement can be critical in accounting for temperature gradients within the conduit system. After being placed on the target portions, the probes can obtain temperature data along the target portions. The obtained temperature data can be transmitted to processor 106, which can then further process the data.

After the temperature data is obtained, a thermal profile of the conduit system can be created. In doing so, the data from each probe is compiled at a defined rate for a designated period of time. As an example, the temperature data can represent temperature readings per minute over the course of a month. Accordingly, at step 810, the method 800 can include determining an average rate of temperature change along each identified target portion based on the obtained temperature data for a designated period of time. Notably, processor 106 can be utilized to determine the average rates of temperature change. Once the average rates of temperature change are determined, a graph and/or table can be created which can display the determined average rates of temperature change for a defined rate over the designated period of time. FIGS. 2 and 3 respectively show a table of average rates of temperature change for the probes in a system and a graph which displays the results.

Once the average rates of temperature change are determined for the conduit system, the thermal behavior of the system can be determined by determining the sensitivity of different sections of the system to heat transfer. FIG. 3 illustrates that probes 2, 6, 7, and 8 are below ground and, therefore, experience the least amount of temperature fluctuations of the probes. However, probes 3 and 5 are partially covered by shade and, therefore, have a greater sensitivity to changes in temperature than probes 2, 6, 7, and 8. Probes 1 and 4 have the most exposure to solar radiation and consequently have the highest sensitivity to temperature changes. The thermal behavior of the conduit system can be further defined by having each probe represent a certain volume of the conduit system. Each probe can represent 100 percent of a thermal gradient volume, however, the invention is not so limited. For example, if 50 percent of a conduit was above ground and 50 percent was below ground then, one probe would represent 100 percent of the above the ground portion and another probe would represent 100 percent of the below ground portion. FIG. 1 can serve to provide an illustration of this concept.

The method 800 can also include determining a thermal mixing zone between the probe for one target portion and another probe for another target portion in the system based on a type of substance between the probe and other probe at step 812. Multiple thermal mixing zones can be determined throughout the system and between various probes in the system. Determining the types of substances in the conduit system is important because some liquids like diesel have low heat conductance values (diesel, 0.078 BTU/hr-ft-° F.) and others have high values like water (0.363 BTU/hr-ft-° F.). The heat conductance values determine how large or small the thermal mixing zone is. FIG. 4 illustrates a thermal mixing zone in a conduit which includes water and diesel. The volume of the thermal mixing zone can be set in accordance with engineering standards. For example, if the conduit of FIG. 4 was filled with diesel it can be safe to assume that only 25 percent of the volume will be affected by thermal gradients, which can lead one to assume a 25 percent mixing zone. Best engineering judgment makes this determination based upon known operating conditions and the types of substances contained within the conduit. Once the thermal mixing zones have been determined for the system, the method 800 can include determining a thermal model for the identified target portions which can be based on one or more of the determined average rates of temperature change, the volumes of the target portions, and the determined thermal mixing zones at step 814.

For the purposes of the calculations that follow, the following variables, among others, will be utilized: \acute{α}=Compressibility, ΔP=Change in Pressure, ΔV_{L}=Change in Volume of Liquid, β_{L}=Thermal Expansion Coefficient of Liquid, V_{Lo}=Initial Liquid Volume, ΔT_{L}=Change in Temperature, Aₚₑ=Surface Area of Conduit Exterior, rₒ=Radius of Conduit Exterior, βₚ=Thermal Expansion Coefficient of Conduit Material, L_{To}=Length of Conduit at Initial Temperature, ΔTₚ=Change in Conduit Temperature, V_{pTo}=Volume of Conduit at Initial Temperature, rᵢ=Radius of Inside Conduit Diameter, V_{pT2}=Volume of Conduit at Final Temperature, L_{T2}=Length of Conduit at Final Temperature, ΔVₚ=Change in Conduit Volume, M_{P}=Mass of Isolated Conduit, D_{L}=Density of Conduit Material, M_{P}=Mass of Substance contained in Conduit, D_{P}=Density of Substance contained in Conduit. Q=Heat, C_{pL}=Heat capacity of Substance, C_{pP}=Heat Capacity of Conduit Material.

The thermal model can be utilized in determining an average thermal change across a conduit which contains multiple gradients. As an illustration and referring to FIG. 4, the conduit can be 6 inches, schedule 40 wall piping, which can be 125 feet long between probes 1 and 2. This can represent 186 gallons and assuming a 25 percent mixing zone, the volume of the mixing zone can be determined by V₁ₘᵢₓ₂2=186 gallons*0.25 mixing zone, which equals 47 gallons. For purposes of this illustration, assume that probe 1 represents 417 feet of an above ground portion of a conduit and probe 2 represents 52 feet of an underground portion of a conduit. As noted above, probe 1 can represent the entire above ground portion and probe 2 can represent the entire the underground portion, which would be 621 gallons and 78 gallons respectively in this case.

The temperature effect each probe has on the entire conduit system can be modeled for each probe respectively. With respect to probe 1, the average temperature effect a thermal change in probe 1 has on the entire conduit system is described as follows: ΔT_{1adj}=(ΔT₁*(1−(((V₁ₘᵢₓ₂)/(V₁+V₂))/2))*V₁))/(V_{Lo}). The effect each thermal mixing zone has on the system can be modeled as well. Using the same example, the mixing zone between probe 1 and probe 2 can be described as follows: ΔT₁ₘᵢₓ₂=[(ΔT₁+ΔT₂)/2]*[((V₁ₘᵢₓ₂)/(V₁+V₂))/2)*V₁]/(V_{Lo}). If there was one thermal mixing zone on both sides of probe 2 then the formula can be described as follows: ΔT₁ₘᵢₓ₂ₘᵢₓ₃=[(ΔT₁+ΔT₂+ΔT₃)/3]*{[((V₁ₘᵢₓ₂)/(V₁+V₂))/2)*V₂]+[((V₂ₘᵢₓ₃)/(V₂+V₃))/2)*V₂]}/V_{Lo}. With respect to probe 2, the average temperature effect a thermal change in probe 2 has on the conduit system when two mixing zones are present can be described as follows: ΔT_{2adj}=[ΔT₁+ΔT₂+ΔT₃)/3]*{1−([((V₁ₘᵢₓ₂)/(V₁+V₂))/2)*V₂]+[((V₂ₘᵢₓ₃)/(V₂+V₃))/2)*V₂])}/(V_{Lo}). Once all thermal zones and thermal mixing zones are determined, then the values can be summed to determine the average thermal temperature change across the pipeline. The method 800 can include obtaining pressure data for each identified target portion and for the system at step 816. The pressure data can be transmitted to the processor 106 for processing. After the pressure data has been obtained, the method 800 can include adjusting the obtained pressure data based on the determined thermal model at step 818. FIG. 5 provides a table featuring pressure data and the summation of all the thermal zones and thermal mixing zones, along with the average rate of temperature changes for a specified period of time.

In order to provide a more accurate pressure test, it is ideal to test during ideal testing conditions. It can be ideal to pressure test during times where temperature changes are minimal or during times where temperature changes in different conduit sections have a canceling effect on each other. As an example, if a particular test section consisted of a set of probes, it may be ideal to test during a period of time where one probe would have a canceling effect with the remaining probes. Furthermore, noncompliance testing activities can determine whether implementation activities are successful.

In order to more accurately determine the effects of temperature and pressure on the conduit system, it is important to derive the appropriate coefficients to be utilized in the calculations. One method is through volume addition, which entails adding a measurable amount of test fluid to a target portion that will raise the pressure of the isolated volume. If the total volume of the isolated test section is known then the compressibility of the test fluid in relation to the operating conditions may be calculated as follows: \acute{α}ₑₓₚ=(P_{f}−Pₒ)*V_{Lo}/(3.14*(Y_{f}−Yₒ)*(d/2)²). Another method is by using volume subtraction, which entails bleeding off or subtracting a measurable amount of test fluid off of the test section/target portion that will lower the pressure of the isolated volume. As in the calculation for volume addition, if the total volume of the isolated section is known then the compressibility of the test fluid in relation to the operating conditions can be calculated as follows for volume subtraction: \acute{α}ₑₓₚ=(Pₒ−P_{f})*V_{Lo}/(3.14*(Yₒ−Y_{f})*(d/2)²).

The accuracy of the test results and the derived coefficients can be determined with a calibration check and by utilizing confidence intervals. The math model (see below) can utilize referenced coefficients for compressibility and/or the bulk modulus of elasticity of the liquid contained within the isolated conduit. An assumption under the model is that the fuel pipe/conduit is completely packed with material. This means that 100 percent of the conduit's volume is occupied by a homogeneous fluid. Another assumption that can be made is that the fuel pipe/conduit is completely rigid. If the conduit is completely rigid, then when the internal pressure of the pipeline increases, the conduit/pipeline will not expand radially. In an actual testing environment, one may not necessarily make these assumptions, and therefore, the system can be calibrated prior to conducting the testing. The conduit system calibration takes into account radial conduit/piping expansion and compressible air pockets that may be present within the isolated volume. The calibration takes these factors into account and a system compressibility value is experimentally derived.

The system's compressibility should be derived a few times before each pressure test begins. By doing so, it will act as a calibration check for the conduit system that is tested. Once a satisfactory number of calibration checks are performed, the resulting derived compressibility values are analyzed within a confidence interval to determine the upper confidence bound showing a 95 percent level of confidence that the standard deviation of compressibility could be as large as X. This can be performed as follows: ((((number of calibrations)−1)*sample variance)/(chi squared referenced value))̂(½). After performing this step, the maximum system compressibility at 95 percent confidence can be determined as follows: \acute{α}=(Upper Confidence Bound at 95%)+(Mean of Derived Compressibility Values).

Once the upper confidence bound at 95 percent is determined, then the derived P-coefficient can be calculated using math model equations (a)-(1) using the derived compressibility \acute{α} that follow and the leak rate can be determined from the math model equations that follow (a)-(l): (a.) Volumetric Thermal Expansion of Liquid: ΔV_{L}=β_{L}*V_{Lo}*ΔT_{L}; (b.) Volume of Conduit material is calculated: Vₚ=(π*rₒ²*L_{To})−V_{Lo} (Initial Volume at Initial Temperature); (c.) Mass of the conduit is calculated as Mp V_{P}*D_{P}; (d.) Mass of contained substance is M_{L}=D_{L}*V_{L}; (e.) Energy change of the substance from the measured temperature change: Q=M_{L}*Cp_{L}*ΔT_{L}; (f.) Rearranging the equation from equation (e), the temperature change of the conduit is determined from the contained substance's energy change by its temperature change: ΔT_{P}=Q/(M_{P}*Cp_{P}); (g.) Linear Thermal Expansion of Conduit: ΔLₚ=βₚ*L_{To}*ΔTₚ; (h.) Volume of the conduit at the final temperature is calculated from its linear thermal expansion: V_{pT2}=πrᵢ²L_{T2}; (i.) The volume change of the conduit is calculated as ΔVₚ=V_{pT2}−V_{pTo}; (j.) The overall change in volume accounts for the expansion rates of the substance and the conduit ΔV=ΔV_{L}−ΔV_{P}; (k.) Using the overall change in volume, an adjusted thermal expansion coefficient for the substance can be calculated. This is the volume change with respect to the contained substance: β_{A}=ΔV/(V_{Lo}*ΔT_{L}); (l.) The theoretical pressure change is then calculated using the bulk modulus of elasticity of the substance. The bulk modulus is the inverse of the substance's compressibility. The following equation is arranged to use compressibility but further manipulation can form an equation to use the bulk modulus of elasticity: P-coefficient=ΔP=(ΔV/V_{L0})/\acute{α}; (m.) The theoretical calculated pressure is the sum of the theoretical calculated pressure change and the actual measured initial pressure. The unaccounted volume is found by comparing the difference in pressure changes and rearranging the pressure formula: ΔV_{La}=(P_{TC}−P_{AM})*V_{Lo}/\acute{α}; (n.) Calculated Leak Rate: ΔV_{La}/(t/60). The calculated leak rate can be compared to the established standard of compliance to determine whether the conduit system “Passes” or “Fails.” The established standard for compliance is typically determined by the State.

Another simpler method of determining compliance with established standards can also be provided as well. Once the temperature probes, such as probes 104a-b, have been coupled to the middle portions of the target conduits and the P-coefficients have been defined through calibration, then accurate results can be achieved. The P-coefficient describes the effect that temperature variations have on the pressure of a particular conduit/piping system. The procedure is as follows: (a.) First, the allowable pressure tolerance is determined by APT=((ΔV_{La}/hr)(\acute{α}))/V_{Lo}, where ΔV_{La}/hr represents the maximum allowable leak rate for compliance. Since the P-coefficient is a determined value, the temperature change during the test can be divided by 0.1° F. to determine the magnitude factor (MF). When the pressure testing has been completed, the MF can be multiplied by the P-coefficient and then added to the initially measured pressure (Pᵢ) from the beginning of the test to determine the theoretically calculated pressure (P_{Tc}), which is represented by the following equation: P_{Tc}=Pᵢ+(P-Coefficient)*(MF).

Once the theoretically calculated pressure is determined, the allowable pressure tolerance is subtracted from P_{Tc} and then compared to the final pressure reading to determine whether the system meets the standard of compliance. For example, an underground conduit that contains #2 diesel fuel is pressure tested in the state of Florida. Before the pressure test, it was determined that the pipe was 6 inches in diameter and had a schedule 40 wall thickness. The volume of the isolated conduit was calculated to have a capacity of 1400 gallons. The line of the conduit was properly packed and the initial temperature and pressure readings were 70° F. and 100 psi respectively. Assuming the pressure test lasted 1.5 hours and the final temperature and pressure readings were 71.1° F. and 171 psi respectively, the next step would be to determine whether the conduit system was in compliance. Using the calibration check procedure above, it was found that a pressure change of 9.4 psi occurs for every 0.1° F. change in temperature within the isolated volume of the conduit.

As a result, the MF factor, which has no units, can be calculated as follows: MF=(71.1° F.−70° F.)/0.1=11. The P_{Tc} can now be calculated as follows: P_{Tc}=Pᵢ+9.4(MF)=100 psi+9.4 psi (11)=203.4 psi. Using the APT lookup table, the results show that for a conduit system with a volume of 1400 gallons, the APT is 46.61 psi. Now, the lower limit for ensuring compliance can be calculated as follows: Lower limit=203.4 psi−46.61 psi=156.79 psi. As noted above, the final pressure reading from the test was 171 psi. Since the final pressure reading is greater than the lower limit, the test returns a passing result. After the pressure test has been completed, the leak rate can be calculated and compared to any desired standard. The leak rate can be calculated using actual testing data and the derived P-coefficient as follows: Leak Rate=(((P_{Tc}−P_{f})*V_{Lo})/(\acute{α}))/(t/60), where P_{f} equals the final measured pressure and t equals the duration of the test. Referring now to FIG. 6, is an example of an output of a test run featuring leak rate calculation results and pressure test data.

During the pressure test process, the pressure within the conduit system can be held within the upper and lower pressure limits as noted above. Additionally, depending on temperature increase or decreases it may be necessary to either increase or bleed off pressure during the test. In order to account for these changes, each testing iteration starting from the beginning pressure to the changed pressures is recorded as a separate data set. After the test has been completed, the data set can be compiled by the processor 106 as if it was a straight run. The leak rate can be determined from this straight run set as illustrated in FIG. 7, which features various iterations of test runs. Every test duration, temperature change, and pressure change reading can be summed into one cumulative data set. The simpler calculation method can then be applied to this cumulative data set in order to determine compliance.

In addition to the methods provided above, other methods of testing can be performed. In one embodiment, the test can be by volume, in which a liquid can be added into and taken out of an isolated conduit system in small increments between a high set point and a low set point multiple times during a pressure test. This allows a determination of the leak rate negating effects that temperature changes have on the results. In another embodiment, the test can involve a determination of the thermal expansion of the conduit by heat transfer, which can be determined using equations (e) and (f) from above. In yet another embodiment, the test can involve determining the P-Coefficient and the theoretically calculated pressure using bulk modulus. Since bulk modulus is the inverse of compressibility, and, therefore, may be substituted into any equation using compressibility.

The invention and/or portions of the invention can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is suitable. A typical combination of hardware and software can be a general purpose computer system with a computer program that, when being loaded and executed, controls the computer system such that it carries out the methods described herein.

The invention, as already mentioned, can be embedded in a computer program product, such as magnetic tape, an optically readable disk, or other computer-readable medium for storing electronic data. The computer program product can comprise computer-readable code, (defining a computer program) which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

We claim:

1. A computer-based method for pressure testing in a system, the method comprising:
determining at least one physical characteristic of a system of conduits, wherein the at least one physical characteristic comprises at least one dimension of the conduits;
determining a pressure limit associated with the system based on the at least one physical characteristic;
identifying a target portion of at least one conduit in the system, wherein the target portion is susceptible to having a thermal gradient;
positioning a probe along a middle portion of the identified target portion, wherein the probe obtains temperature data along the identified target portion;
determining an average rate of temperature change along the identified target portion based on the obtained temperature data for a designated period of time;
determining a thermal mixing zone between the probe and another probe in the system based on a type of substance between the probe and the another probe;
determining a thermal model for the identified target portion based on the determined average rate of temperature change, a volume of the identified target portion, and the determined thermal mixing zone;
obtaining pressure data for the identified target portion by pressure testing the identified target portion; and
adjusting the obtained pressure data based on the thermal model.

2. The method of claim 1, wherein the at least one dimension of the conduits comprises at least one of a length, a width, a height, and a volume of the conduits.

3. The method of claim 1, comprising determining a material of the conduits, a substance within the conduits, and a physical state of the substance within the conduits.

4. The method of claim 3, comprising adjusting at least one of the pressure limit and the obtained pressure data based on at least one of material of the conduits, the substance within the conduits, and the physical state of the substance within the conduits.

5. The method of claim 1, wherein the probe and the another probe represent a volume of their respective identified target portions.

6. The method of claim 1, comprising determining a leak rate for the identified target portion based on the obtained pressure data.

7. The method of claim 1, comprising reducing a pressure level in the system when the pressure limit is reached.

8. A computer-based method for pressure testing, the method comprising:
determining a pressure limit associated with a system of conduits;
identifying a target portion of at least one conduit in the system based on the susceptibility of the target portion to having a thermal gradient;
positioning a probe along the target portion;
obtaining temperature data associated with the target portion from the probe at a defined rate for a designated period of time;
determining an average rate of temperature change along the target portion based on the obtained temperature data;
defining a thermal behavior of the target portion based on the determined average rate of temperature change;
determining a thermal mixing zone between the probe and another probe in the system;
generating a thermal model for the target portion based on at least one of the average rate of temperature change, the thermal behavior, a volume of the identified target portion, and the thermal mixing zone;
obtaining pressure data for the target portion by pressure testing the target portion; and
adjusting the obtained pressure data based on the thermal model.

9. The method of claim 8, comprising determining at least one physical characteristic of the system of conduits.

10. The method of claim 9, comprising determining the pressure limit based on the at least one physical characteristic.

11. The method of claim 10, wherein the at least one physical characteristic comprises at least one of a length, a width, a height, and a volume of the conduits, a material of the conduits, a substance within the conduits, and a physical state of the substance within the conduits.

12. The method of claim 8, wherein the pressure limit comprises an upper pressure limit and a lower pressure limit.

13. The method of claim 8, comprising determining a leak rate for the target portion based on the obtained pressure data.

14. The method of claim 8, comprising defining a heat transfer limit of the system to determine a volume of the at least one conduit affected by the thermal mixing zone.

15. The method of claim 8, wherein the probe is placed along a middle portion of the target portion.

16. A storage medium having stored therein machine-readable instructions to, which, when loaded in and executed by a computer, causes the computer to perform the steps of:
determining a pressure limit associated with a system of conduits;
identifying a target portion of at least one conduit in the system based on the susceptibility of the target portion to having a thermal gradient;
obtaining temperature data associated with the target portion from a probe at a defined rate for a designated period of time, wherein the probe is operably coupled to the target portion;
determining an average rate of temperature change along the target portion based on the temperature data;
defining a thermal behavior of the target portion based on the determined average rate of temperature change;
generating a thermal model for the target portion based on at least one of the average rate of temperature change, the thermal behavior, and a volume of the target portion;
obtaining pressure data for the target portion by pressure testing the target portion; and
adjusting the obtained pressure data based on the thermal model.

17. The computer-readable storage medium of claim 16, comprising computer instructions to determine a thermal mixing zone between the probe and another probe in the system.

18. The computer-readable storage medium of claim 17, comprising computer instructions to generate the thermal model based on the thermal mixing zone.

19. The computer-readable storage medium of claim 16, comprising computer instructions to determine a leak rate for the target portion based on the obtained pressure data.

20. The computer-readable storage medium of claim 16, comprising determining at least one physical characteristic of the system of conduits, wherein the at least one physical characteristic comprises at least one of a length, a width, a height, and a volume of the conduits, a material of the conduits, a substance within the conduits, and a physical state of the substance within the conduits, and wherein the at least one physical characteristic is utilized in determining the pressure limit.
